(19) United States
(12) Patent Application Publication
(10) Pub. No.: US 2003/0164033 A1
(43) Pub. Date: Sep. 4, 2003

(54) System and method for tire pressure monitoring including vehicle immobilization

(76) Inventors: Riad Ghabra, Dearborn Heights, MI (US); John S. Nantz, Brighton, MI (US); Qingfeng Tang, Novi, MI (US); Abdul Rahmen Alcodray, Dearborn, MI (US)

Correspondence Address: BROOKS & KUSHMAN P.C. / LEAR CORPORATION, 1000 TOWN CENTER TWENTY-SECOND FLOOR, SOUTHFIELD, MI, 48075, US

(21) Appl. No.: 10/229,789

(22) Filed: Aug. 28, 2002

Related U.S. Application Data
(60) Provisional application No. 60/360,762, filed on Mar. 1, 2002.

(51) Int. Cl. G01M 17/02

(52) U.S. Cl. 73/146

(57) ABSTRACT

A system and method for remote monitoring of vehicle tire pressure and remote vehicle immobilization. Transmitters are provided for mounting in the vehicle tires for transmitting wireless tire information signals. A receiver is provided for mounting on the vehicle for receiving both the tire information signals transmitted by the transmitters and a remote wireless encrypted vehicle immobilization signal including an authentication code. A controller is provided for mounting on the vehicle in communication with the receiver. The controller processes the tire information signals received by the receiver to convey tire pressure information to a vehicle occupant, and processes the encrypted vehicle immobilization signal received by the receiver to determine if the immobilization signal is valid based on the authentication code and to generate a control signal for use in immobilizing the vehicle if the immobilization signal is determined valid.

### CROSS REFERENCE TO RELATED APPLICATION

This application claims the benefit of U.S. provisional application Serial No. 60/360,762 filed on Mar. 1, 2002.

### BACKGROUND OF THE INVENTION

1. Field of the Invention

The present invention relates to a system and method for wireless vehicle tire pressure monitoring that includes a vehicle immobilization system and method.

2. Background

Under certain circumstances, law enforcement officials may engage in the pursuit of an individual using a motor vehicle in an attempt to flee such officials. The vehicles involved in such pursuit situations can reach high speeds, endangering both individuals and property. Indeed, high speed pursuit can result in significant property damage, as well as serious personal injury including death. To reduce the incidence of personal injury and/or property damage, there exists a need for a method by which law enforcement officials could remotely disable or stop a vehicle in which an individual is attempting to flee, thereby eliminating or significantly reducing the occurrence of high speed pursuit situations.

It is known in the automotive industry to provide for wireless monitoring of vehicle tire parameters, particularly tire pressure. In such tire pressure monitoring systems, tire pressure sensors and radio frequency (RF) transmitters are mounted inside each tire, typically adjacent the inflation valve stem. In each tire, the tire pressure sensed by the tire pressure sensor is transmitted by the transmitter to a receiver/controller located on the vehicle. The tire pressure information delivered to the receiver/controller by the RF signals from the transmitters is subsequently conveyed to a vehicle operator or occupant, typically using a display unit.

It would therefore be desirable to provide a system and method for monitoring tire pressure in a vehicle that allows for law enforcement officials to remotely immobilize the vehicle. Such a system and method would preferably include an RF receiver for use in receiving wireless tire pressure data signals for use in tire pressure monitoring, as well as for use in receiving a remote wireless vehicle immobilization command. Such a system and method would thereby eliminate or significantly reduce the incidence of high speed pursuit situations, and the personal injury and/or property damage problems described above associated therewith.

### SUMMARY OF THE INVENTION

Accordingly, the present invention provides an improved system and method for vehicle tire pressure monitoring that includes a system and method for vehicle immobilization.

According to the present invention, then, in a vehicle having an engine and a plurality of tires, each tire having a transmitter mounted therein for transmitting wireless tire information signals, a system is provided for remote monitoring of tire pressure and for remote immobilization of the vehicle. The system comprises a receiver for mounting on the vehicle, the receiver for receiving both the tire information signals transmitted by the transmitters and a remote wireless encrypted vehicle immobilization signal including an authentication code. The system further comprises a controller for mounting on the vehicle and to be provided in communication with the receiver, the controller for processing the tire information signals received by the receiver to convey tire pressure information to a vehicle occupant. The controller is also for processing the encrypted vehicle immobilization signal received by the receiver to determine if the immobilization signal is valid based on the authentication code and to generate a control signal for use in immobilizing the vehicle if the immobilization signal is determined valid.

Also according to the present invention, in a vehicle having an engine and a plurality of tires, a system is provided for remote monitoring of tire pressure and for remote immobilization of the vehicle. The system comprises a plurality of transmitters, each transmitter for mounting in one of the plurality of tires and for transmitting wireless tire information signals for use in conveying tire pressure information to a vehicle occupant. The system further comprises a receiver for mounting on the vehicle, the receiver for receiving both the tire information signals transmitted by the transmitters and a remote wireless encrypted vehicle immobilization signal including an authentication code. The receiver is for processing the encrypted vehicle immobilization signal to determine if the immobilization signal is valid based on the authentication code and to generate a control signal for use in immobilizing the vehicle if the immobilization signal is determined valid.

Still further according to the present invention, in a vehicle having an engine and a plurality of tires, a system for remote monitoring of tire pressure and for remote immobilization of the vehicle is provided. The system comprises a plurality of transmitters, each transmitter for mounting in one of the plurality of tires and for transmitting wireless tire information signals for use in conveying tire pressure information to a vehicle occupant. The system further comprises a receiver for mounting on the vehicle, the receiver for receiving both the tire information signals transmitted by the transmitters and a remote wireless encrypted vehicle immobilization signal including an authentication code. The receiver is provided in communication with an engine controller, the engine controller for processing the encrypted vehicle immobilization signal to determine if the immobilization signal is valid based on the authentication code and to immobilize if the immobilization signal is determined valid.

Also according to the present invention, in a vehicle having an engine and a plurality of tires, each tire having a transmitter mounting therein for transmitting wireless tire information signals for use in conveying tire pressure information to a vehicle occupant, a method is provided for remote monitoring of tire pressure and for remote immobilization of the vehicle. The method comprises providing a receiver for mounting on the vehicle, the receiver for receiving both the tire information signals transmitted by the transmitters and a remote wireless encrypted vehicle immobilization signal including an authentication code. The receiver is for processing the encrypted vehicle immobilization signal to determine if the immobilization signal is valid based on the authentication code and to generate a control signal for use in immobilizing the vehicle if the immobilization signal is determined valid.

Still further according to the present invention, in a vehicle having an engine and a plurality of tires, each tire having a transmitter mounted therein for transmitting wireless tire information signals for use in conveying tire pressure information to a vehicle occupant, a method for remote monitoring of tire pressure and for remote immobilization of the vehicle is provided. The method comprises providing a receiver for mounting on the vehicle, the receiver for receiving both the tire information signals transmitted by the transmitters and a remote wireless encrypted vehicle immobilization signal including an authentication code. The receiver is provided in communication with an engine controller, the engine controller for processing the encrypted vehicle immobilization signal to determine if the immobilization signal is valid based on the authentication code and to immobilize if the immobilization signal is determined valid.

These and other features and advantages of the present invention will be readily apparent upon consideration of the following detailed description of the invention in conjunction with the accompanying drawings.

### BRIEF DESCRIPTION OF THE DRAWINGS

FIG. 1 is a simplified, representative block diagram of one embodiment of the system of the present invention for tire pressure monitoring and vehicle immobilization;

FIG. 2 is a simplified, representative block diagram of another embodiment of the system of the present invention for tire pressure monitoring and vehicle immobilization; and

FIG. 3 is a simplified, representative flow chart of the method of the present invention for tire pressure monitoring and vehicle immobilization.

### DETAILED DESCRIPTION OF THE PREFERRED EMBODIMENTS

Referring now to the Figures, the preferred embodiments of the present invention will now be described in detail. As previously noted, law enforcement officials may engage in the pursuit of an individual using a motor vehicle in an attempt to flee. The vehicles involved in such pursuit situations can reach high speeds, endangering both individuals and property. To reduce the incidence of personal injury and/or property damage, there exists a need for a method by which law enforcement officials could remotely disable or stop a vehicle in which an individual is attempting to flee, thereby eliminating or significantly reducing the occurrence of high speed pursuit situations.

As also noted above, it is known in the automotive industry to provide for wireless monitoring of vehicle tire parameters, particularly tire pressure. In such tire pressure monitoring systems, tire pressure sensors and RF transmitters are mounted inside each tire, typically adjacent the inflation valve stem. In each tire, the tire pressure sensed by the tire pressure sensor is transmitted by the transmitter to a receiver/controller located on the vehicle. The tire pressure information delivered to the receiver/controller by the RF signals from the transmitters is subsequently conveyed to a vehicle operator or occupant, typically using a display unit.

In light of the above noted problems associated with high speed pursuit situations, it would be desirable to provide a system and method for monitoring tire pressure in a vehicle that allows for law enforcement officials to remotely immobilize the vehicle. Such a system and method would preferably include an RF receiver for use in receiving wireless tire pressure data signals for use in tire pressure monitoring, as well as for use in receiving a remote wireless vehicle immobilization command. Such a system and method would thereby eliminate or significantly reduce the incidence of high speed pursuit situations, as well as the personal injury and/or property damage problems described above associated therewith.

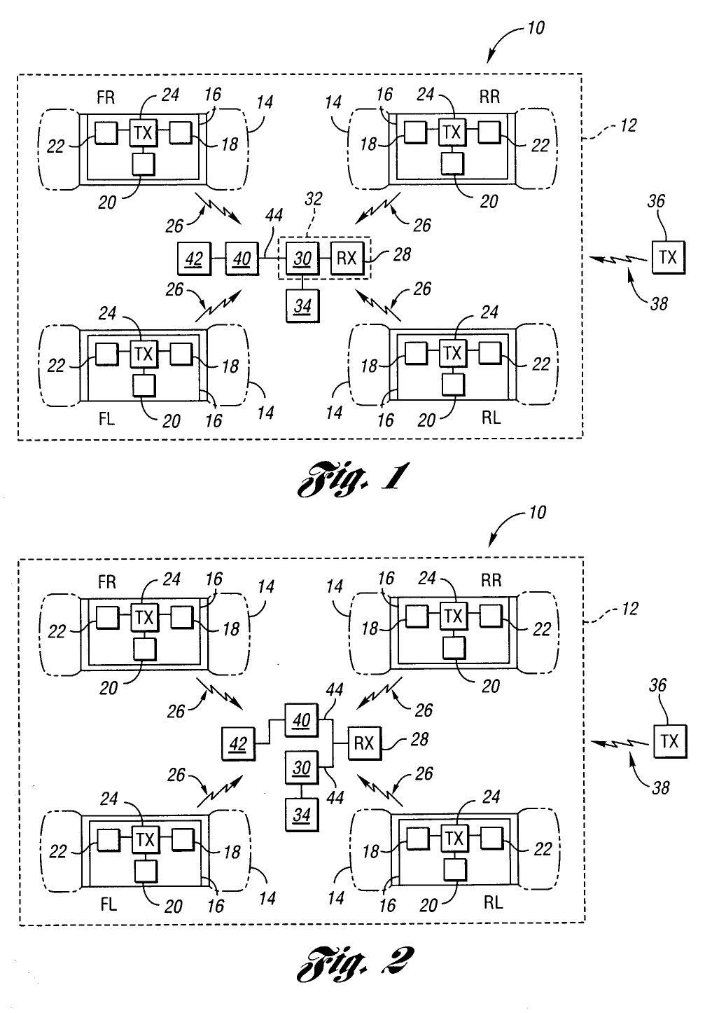

In that regard, referring now to FIG. 1, a simplified, representative block diagram of the system of the present invention for remote tire pressure monitoring and vehicle immobilization is shown, denoted generally by reference numeral 10. As seen therein, the system (10) is designed for use in a vehicle (12) having a plurality of tires (14). Each one of the plurality of tires (8) has a tire location associated therewith, such as front left (FL), front right (FR), rear left (RL), and rear right (RR). It should be noted here that while the present invention is described herein for use in an automotive vehicle having four tires, such an environment is exemplary only. That is, the present invention is suitable for use in any type of vehicle having any number of tires.

The system (10) preferably includes a plurality of tire monitors (16). Each tire monitor (16) is provided for mounting in one of the plurality of tires (14). In that regard, each tire monitor (16) is preferably mounted inside the tire (14) on an associated rim adjacent the tire inflation valve stem (not shown), although any mounting location known in the art may be used. Each tire monitor (16) preferably includes at least one sensor (18) and/or other device (not shown), for sensing, determining and/or monitoring at least the pressure of the associated tire (14). It should be noted, however, that each tire monitor (16) may also be equipped to sense, determine and/or monitor any number of additional tire parameters, such as temperature, status (i.e., whether the tire is rotating) and/or speed, in any fashion well known to those of ordinary skill in the art. For example, each tire monitor (16) may also include a temperature sensor (20) for use in sensing the temperature of the associated tire (14), as well as a rotation sensor (22) for use in sensing rotation of the associated tire (14).

Still referring to FIG. 1, each tire monitor (16) also includes a transmitter (24) in communication with pressure sensor (18), temperature sensor (20) and rotation sensor (22). Transmitters (24) transmit tire information signals (26) to convey pressure data, temperature data, and status data for each tire (14). In that regard, signals (26) are preferably radio frequency (RF) signals, although other signal types known in the art, such as low frequency (LF) could be employed. Once again, it should be noted that transmitters (24) may also transmit, as part of or separate from signal (26), a signal or signals including data concerning any of a number of other tire parameters in addition to pressure, temperature and status, such as tire speed, as sensed, measured and/or determined by an appropriately equipped tire monitor (16).

It should also be noted that each tire monitor (16) also typically includes a battery (not shown), and that transmitters (24) may also transmit, again as part of or separate from signal (26), a signal or signals representative of the status of such a battery, including a low battery status. It should still further be noted that system (10) may also be configured and/or programmed to determine, identify or recognize the particular tire location (e.g., front left (FL), front right (FR), rear left (RL), rear right (RR)) associated with an RF signal (26) received from a tire transmitter (24) in any fashion known in the art.

Referring still to FIG. 1, the system (10) of the present invention also includes a receiver (28) for mounting on the vehicle (12) for receiving the signals (26) transmitted by transmitters (24). In that regard, receiver (28) may comprise one or more antenna (not shown) to be located at one or more selected sites on the vehicle (12).

Still referring to FIG. 1, the system (10) of the present invention further comprises a controller (30) for mounting on vehicle (12) and to be provided in communication with receiver (28). Controller (30), which preferably comprises an appropriately programmed microprocessor, is for processing tire information signals (26) received by receiver (28) from transmitters (24) delivering the tire pressure, temperature, status and/or other data for use in conveying at least tire pressure information to a vehicle operator. It should also be noted that receiver (28) and controller (30) may be part of a single control unit (32) for mounting on vehicle (12).

According to the system (10) of the present invention, controller (30) is preferably provided in communication with a display unit (34) mounted in the passenger compartment of vehicle (12). Display unit (32) is used by controller (30) to convey at least tire pressure information to the vehicle operator, and may comprise a Light Emitting Diode (LED) display or a lighted icon in the vehicle dashboard or a vehicle console. Alternatively, or in addition, audible means for conveying at least tire pressure information to the vehicle operator, such as tones or speech, may be used. Information concerning other tire parameters, such as tire location (i.e., front left (FL), front right (FR), rear left (RL), or rear right (RR)), temperature, speed and/or battery status, may also be conveyed to the vehicle operator. The information conveyed to the vehicle operator may include a warning, which may also be audible, if tire pressure, or other tire parameters, such as temperature, and/or battery status are outside recommended ranges.

Still referring to FIG. 1, each sensor (18, 20, 22) and/or transmitter (24) preferably has a unique identification code associated therewith. Such identification codes serve to particularly associate sensors (18, 20, 22) and/or transmitters (24) with vehicle (12). In that regard, each transmitter (24) also preferably transmits such identification code for receipt by receiver (28) and for use by controller (30) in determining that the signals (26) received by receiver (28) are associated with the vehicle (12). Transmitters (24) may transmit the identification codes as part of signal (24), or as a separate signal (not shown). In such a fashion, controller (30) disregards any tire information signals which may be transmitted from any nearby vehicle and received by receiver (28).

It should be noted that the pressure, temperature, status and/or other data may be transmitted by transmitters (24) together as part of a single signal (26). Alternatively, however, such data may be transmitted by transmitters (24) as separate signals (26). In that event, the previously described unique identification code associated with sensors (18, 20, 22) and/or transmitters (24) may be transmitted with the data for a particular tire (14) as part of the separate signals (26). In such a fashion, the pressure, temperature, status and/or other data may be properly associated by controller (30) with vehicle (12) and/or particular tire locations (i.e., Front Right (FR), Front Left (FL), Rear Right (RR), Rear Left (RL)).

The system (10) may further comprise a remote vehicle immobilization transmitter (36) for use in transmitting a wireless vehicle immobilization signal or command (38). As will be described in greater detail below, immobilization signal (38) is a universal encrypted signal operative to slow down and/or stop vehicle (12). It should be noted that, like signals (26), immobilization signal (38) is preferably a radio frequency (RF) signal, although again other signal types known in the art, such as LF could be employed.

As previously described, receiver (28) is provided for receiving the tire information signals (26) transmitted by transmitters (24) for use in conveying at least tire pressure information to a vehicle occupant. Receiver (28) is also provided for receiving the remote wireless vehicle immobilization signal (38) transmitted by remote transmitter (36). It should also be noted that receiver (28) may be further provided for receiving a wireless signal (not shown), for example a radio frequency signal, for use in a remote keyless entry (RKE) system for vehicle (12), such as an RKE system for locking or unlocking a vehicle door (not shown). In that regard, receiver (28) may be provided in communication with an RKE controller (not shown) and/or one or more locking mechanism actuators (not shown) mounted on the vehicle (12).

Referring still to FIG. 1, remote transmitter (36) is preferably mobile, such as by being mounted on a law enforcement vehicle (not shown). When vehicle (12) is being operated by an individual attempting to flee law enforcement officials, remote transmitter (36) is used by law enforcement officials to transmit a wireless encrypted immobilization signal (38) for receipt by receiver (28) on vehicle (12). In particular, immobilization signal (38) comprises an encrypted “STOP” message, togther with an authentication code. In that regard, immobilization signal (38) preferably comprises an encrypted “STOP” message, together with a random seed that is used to encrypt that message.

As previously described, receiver (28) is provided in communication with controller (30). As also previously described, controller (30) preferably comprises an appropriately programmed microprocessor, and is for processing tire information signals (26) received by receiver (28) from transmitters (24) delivering the tire pressure, temperature, status and/or other data for use in conveying at least tire pressure information to a vehicle operator using display unit (34). In addition, controller (30) is also programmed and/or includes control logic for decrypting immobilization signal (38) received by receiver (28) and for determining if immobilization signal (38) is valid. In particular, controller (30) uses the transmitted random seed to calculate if immobilization signal (38) is valid. In this manner, only immobilization signals (38) from authorized sources, such as remote transmitter (36) in a law enforcement vehicle (not shown), can be used to slow down and/or stop vehicle (12).

Referring still to FIG. 1, controller (30) is also provided in communication with engine controller or engine control module (40), which itself is provided in communication with engine (42). Upon decoding immobilization signal (38) and confirming that immobilization signal (38) is valid, controller (30) sends a control signal (not shown) to engine controller (40) for use in immobilizing vehicle (12). Preferably, such a control signal, upon receipt by engine controller (40) is operative to cause engine controller (40) to reduce, limit and/or gradually cut-off fuel to engine (42), thereby slowing and/or stopping vehicle (12).

Controller (30) and engine controller (40) are preferably provided in communication with each other using a data bus (44). In that regard, immobilization signal (38) transmitted by remote transmitters (36) and provided to controller (30) by receiver (28) is preferably converted by controller (30) to a bus signal (not shown), such as the control signal previously described, according to any known data transmission protocol. Engine controller (40), connected to data bus (46) and compatible with such data transmission protocol, collects such a bus signal for use in immobilizing vehicle (12) as previously described.

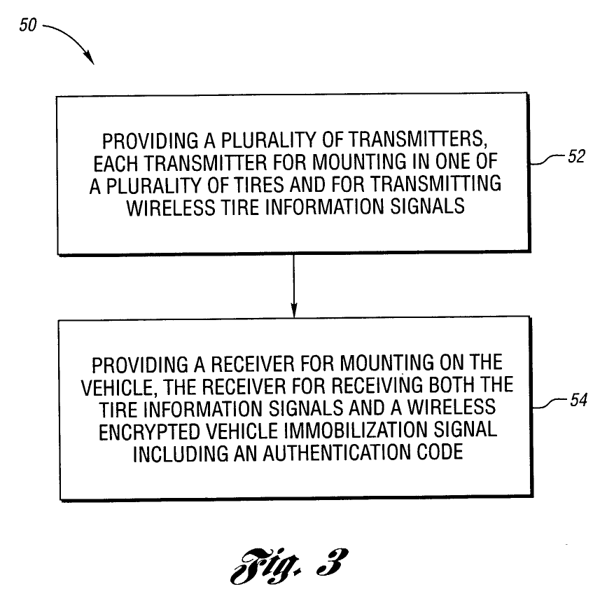

Referring next to FIG. 2, a simplified, representative block diagram of an alternative embodiment of the system of the present invention for remote tire pressure monitoring and vehicle immobilization is shown, denoted generally again by reference numeral 10. In that regard, the same reference numerals are used in FIG. 2 to refer to similar components described previously in connection with FIG. 1.

As described above in connection with FIG. 1, receiver (28) is provided for receiving the tire information signals (26) transmitted by transmitters (24) for use in conveying at least tire pressure information to a vehicle occupant. Receiver (28) is again also provided for receiving the remote wireless vehicle immobilization signal (38) transmitted by remote transmitter (36). It should again be noted that receiver (28) may be further provided for receiving a wireless signal (not shown) for use in an RKE system (not shown) for vehicle (12).

Once again, when vehicle (12) is being operated by an individual attempting to flee law enforcement officials, remote transmitter (36) is used by law enforcement officials to transmit a wireless encrypted immobilization signal (38) for receipt by receiver (28) on vehicle (12). In particular, immobilization signal (38) comprises an encrypted “STOP” message, togther with an authentication code. In that regard, immobilization signal (38) preferably comprises an encrypted “STOP” message, together with a random seed that is used to encrypt that message.

As seen in FIG. 2, receiver (28) is provided in communication with both controller (30) and engine controller (40). In this embodiment, controller (30) again preferably comprises an appropriately programmed microprocessor, and is for processing tire information signals (26) received by receiver (28) from transmitters (24) delivering the tire pressure, temperature, status and/or other data for use in conveying at least tire pressure information to a vehicle operator via display unit (34).

In the embodiment depicted in FIG. 2, however, receiver (28) itself may be provided with appropriate control logic, such as a microprocessor, and/or programmed for decrypting immobilization signal (38) received by receiver (28) and determining if immobilization signal (38) is valid. In particular, receiver (28) uses the transmitted random seed to calculate if immobilization signal (38) is valid. Once again, in this manner, only immobilization signals (38) from authorized sources, such as remote transmitter (36) in a law enforcement vehicle (not shown), can be used to slow down and/or stop vehicle (12).

As noted above, receiver (28) is provided in communication with engine controller or engine control module (40), which itself is provided in communication with engine (42). Upon decoding immobilization signal (38) and confirming that immobilization signal (38) is valid, receiver (28) sends a control signal (not shown) to engine controller (40) for use in immobilizing vehicle (12). Preferably, such a control signal, upon receipt by engine controller (40) is operative to cause engine controller (40) to reduce, limit and/or gradually cut-off fuel to engine (42).

Alternatively, however, receiver (28) may simply receiver immobilization signal (38). In that regard, engine controller (40) may be provided with appropriate control logic, such as a microprocessor, and/or programmed for decrypting immobilization signal (38) received by receiver (28) and determining if immobilization signal (38) is valid, and immobilizing vehicle (12) in the fashion described above if immobilization signal (38) is determined valid.

In the embodiment depicted in FIG. 2, receiver (28) and engine controller (40) are preferably provided in communication with each other using a data bus (44). In that regard, immobilization signal (38) transmitted by remote transmitters (36) and received by receiver (28) is preferably converted to a bus signal (not shown), such as the control signal previously described, according to any known data transmission protocol. Engine controller (40), connected to data bus (46) and compatible with such data transmission protocol, collects such a bus signal for use in immobilizing vehicle (12) as previously described.

Referring next to FIG. 3, a simplified, representative flowchart of the method of the present invention, denoted generally by reference numeral 50, is shown for remote monitoring of tire pressure and vehicle immobilization. As seen therein, the method (50) may comprise providing (52) a plurality of transmitters, each transmitter for mounting in one of the plurality of tires and for transmitting tire information signals to deliver at least tire pressure data for use in conveying at least tire pressure information to a vehicle occupant. In that regard, as previously described in detail in connection with FIG. 1, such transmitters may also transmit tire temperature, status and/or other data, and a controller processing such tire information signals to convey tire pressure, temperature and/or other information to the vehicle occupant using the display.

As previously described, controller may also convey tire location information to the vehicle occupant using the display. As also described above, the pressure, temperature, status and/or other data may be transmitted by transmitters together as part of a single tire information signal, or as separate signals.

Still referring to FIG. 3, the method (50) of the present invention may further comprise providing (54) a receiver for mounting on the vehicle, the receiver for receiving both the tire information signals transmitted by the transmitters and a remote wireless encrypted vehicle immobilization signal including an authentication code. As described above, the receiver may be provided in communication with an engine controller, the engine controller for processing the encrypted vehicle immobilization signal to determine if the immobilization signal is valid based on the authentication code and to immobilize the vehicle if the immobilization signal is determined valid.

Alternatively, as also previously described, the receiver may also be provided for processing the encrypted vehicle immobilization signal to determine if the immobilization signal is valid based on the authentication code and to generate a control signal for use in immobilizing the vehicle if the immobilization signal is determined valid. In another alternative embodiment, the receiver may be provided in communication with a controller, the controller for processing the tire information signals received by the receiver to convey tire pressure information to a vehicle occupant, and for processing the encrypted vehicle immobilization signal received by the receiver to determine if the immobilization signal is valid based on the authentication code and to generate a control signal for use in immobilizing the vehicle if the immobilization signal is determined valid.

It should again be noted that the controller and/or receiver are preferably provided in communication with the engine controller over a data bus. The vehicle immobilization signal is preferably converted to a bus signals, such as the control signal previously described. The engine controller collects such a bus signal for use in immobilizing the vehicle, such as in the fashion previously described.

As also described above in connection with FIG. 1, according to the method (50) of the present invention, each transmitter provided preferably has a unique identification associated therewith. In that regard, each transmitter is also for transmitting the associated identification for use in determining whether tire pressure data is associated with the vehicle and/or determining a tire location as previously described. As also described above, each transmitter is preferably provided in communication with pressure, temperature and rotation sensors for sensing tire pressure, temperature and status and for use by the transmitter for transmitting tire pressure, temperature and status data. Each transmitter, pressure sensor, temperature sensor and rotation sensor together comprise a tire monitor to be mounted in the tire as described in detail above in connection with FIG. 1.

It should be noted that the simplified flowchart depicted in FIG. 3 is exemplary of the method (50) of the present invention. In that regard, the method (50) may be executed in sequences other than those shown in FIG. 3, including the execution of a subset of the steps shown and/or the execution of one or more steps simultaneously.

From the foregoing description, it can be seen that the present invention provides a system and method for vehicle tire pressure monitoring and vehicle immobilization. The system and method preferably include an RF receiver for use in receiving both wireless tire pressure data signals for use in tire pressure monitoring, as well as a remote wireless vehicle immobilization signal or command. The system and method of the present invention thereby eliminate or significantly reduce the incidence of high speed pursuit situations, as well as the personal injury and/or property damage problems described above associated therewith.

While various embodiments of the invention have been illustrated and described, it is not intended that these embodiments illustrate and describe all possible forms of the present invention. Rather, the words used in the specification are words of description rather than limitation, and it is understood that various changes may be made without departing from the spirit and scope of the invention. Indeed, many alternatives, modifications, and variations will be apparent to those skilled in the art in light of the foregoing description, and the present invention is intended to embrace all such alternatives.

What is claimed is:

1. In a vehicle having an engine and a plurality of tires, each tire having a transmitter mounted therein for transmitting wireless tire information signals, a system for remote monitoring of tire pressure and for remote immobilization of the vehicle comprising:
a receiver for mounting on the vehicle, the receiver for receiving both the tire information signals transmitted by the transmitters and a remote wireless encrypted vehicle immobilization signal including an authentication code; and
a controller for mounting on the vehicle and to be provided in communication with the receiver, the controller for processing the tire information signals received by the receiver to convey tire pressure information to a vehicle occupant, and for processing the encrypted vehicle immobilization signal received by the receiver to determine if the immobilization signal is valid based on the authentication code and to generate a control signal for use in immobilizing the vehicle if the immobilization signal is determined valid.

2. The system of claim 1 wherein the controller is provided in communication with an engine controller, the control signal is transmitted by the controller to the engine controller, and the engine controller immobilizes the vehicle by limiting fuel to the vehicle engine.

3. The system of claim 1 wherein the receiver and the controller together comprise a control unit, the control unit for mounting on the vehicle.

4. The system of claim 2 wherein the controller is provided in communication with the engine controller over a data bus, and the controller converts the vehicle immobilization signal to the control signal for transmission to the engine controller over the data bus.

5. The system of claim 1 wherein the wireless encrypted vehicle immobilization signal is transmitted from a mobile transmitter remote from the vehicle.

6. The system of claim 1 wherein the receiver is further for receiving a wireless signal for use in a remote keyless entry system.

7. In a vehicle having an engine and a plurality of tires, a system for remote monitoring of tire pressure and for remote immobilization of the vehicle comprising:
a plurality of transmitters, each transmitter for mounting in one of the plurality of tires and for transmitting wireless tire information signals for use in conveying tire pressure information to a vehicle occupant; and
a receiver for mounting on the vehicle, the receiver for receiving both the tire information signals transmitted by the transmitters and a remote wireless encrypted vehicle immobilization signal including an authentication code, and for processing the encrypted vehicle immobilization signal to determine if the immobilization signal is valid based on the authentication code and to generate a control signal for use in immobilizing the vehicle if the immobilization signal is determined valid.

8. The system of claim 7 wherein the receiver is provided in communication with an engine controller, the control signal is transmitted by the receiver to the engine controller, and the engine controller immobilizes the vehicle by limiting fuel to the vehicle engine.

9. The system of claim 7 wherein the receiver is part of a control unit, the control unit for mounting on the vehicle and including a controller in communication with the receiver, the controller for processing the tire information signals to convey tire pressure information to the vehicle occupant.

10. The system of claim 8 wherein the receiver is provided in communication with the engine controller over a data bus, and the receiver converts the vehicle immobilization signal to the control signal for transmission to the engine controller over the data bus.

11. The system of claim 7 wherein the wireless encrypted vehicle immobilization signal is transmitted from a mobile transmitter remote from the vehicle.

12. The system of claim 7 wherein the receiver is further for receiving a wireless signal for use in a remote keyless entry system.

13. In a vehicle having an engine and a plurality of tires, a system for remote monitoring of tire pressure and for remote immobilization of the vehicle comprising:
a plurality of transmitters, each transmitter for mounting in one of the plurality of tires and for transmitting wireless tire information signals for use in conveying tire pressure information to a vehicle occupant; and
a receiver for mounting on the vehicle, the receiver for receiving both the tire information signals transmitted by the transmitters and a remote wireless encrypted vehicle immobilization signal including an authentication code, wherein the receiver is provided in communication with an engine controller, the engine controller for processing the encrypted vehicle immobilization signal to determine if the immobilization signal is valid based on the authentication code and to immobilize if the immobilization signal is determined valid.

14. The system of claim 13 wherein the engine controller immobilizes the vehicle by limiting fuel to the vehicle engine.

15. The system of claim 13 wherein the receiver is part of a control unit, the control unit for mounting on the vehicle and including a controller in communication with the receiver, the controller for processing the tire information signals to convey tire pressure information to the vehicle occupant.

16. The system of claim 13 wherein the receiver is provided in communication with the engine controller over a data bus, and the receiver converts the vehicle immobilization signal for transmission to the engine controller over the data bus.

17. The system of claim 13 wherein the wireless encrypted vehicle immobilization signal is transmitted from a mobile transmitter remote from the vehicle.

18. The system of claim 13 wherein the receiver is further for receiving a wireless signal for use in a remote keyless entry system.

19. In a vehicle having an engine and a plurality of tires, each tire having a transmitter mounting therein for transmitting wireless tire information signals for use in conveying tire pressure information to a vehicle occupant, a method for remote monitoring of tire pressure and for remote immobilization of the vehicle comprising providing a receiver for mounting on the vehicle, the receiver for receiving both the tire information signals transmitted by the transmitters and a remote wireless encrypted vehicle immobilization signal including an authentication code, and for processing the encrypted vehicle immobilization signal to determine if the immobilization signal is valid based on the authentication code and to generate a control signal for use in immobilizing the vehicle if the immobilization signal is determined valid.

20. The method of claim 19 wherein the receiver is provided in communication with an engine controller, the control signal is transmitted by the receiver to the engine controller, and the engine controller immobilizes the vehicle by limiting fuel to the vehicle engine.

21. The method of claim 19 wherein the receiver is part of a control unit, the control unit for mounting on the vehicle and including a controller in communication with the receiver, the controller for processing the tire information signals to convey tire pressure information to the vehicle occupant.

22. The method of claim 20 wherein the receiver is provided in communication with the engine controller over a data bus, and the receiver converts the vehicle immobilization signal to the control signal for transmission to the engine controller over the data bus.

23. The method of claim 19 wherein the wireless encrypted vehicle immobilization signal is transmitted from a mobile transmitter remote from the vehicle.

24. The system of claim 1 wherein the receiver is further for receiving a wireless signal for use in a remote keyless entry system.

25. In a vehicle having an engine and a plurality of tires, each tire having a transmitter mounted therein for transmitting wireless tire information signals for use in conveying tire pressure information to a vehicle occupant, a method for remote monitoring of tire pressure and for remote immobilization of the vehicle comprising providing a receiver for mounting on the vehicle, the receiver for receiving both the tire information signals transmitted by the transmitters and a remote wireless encrypted vehicle immobilization signal including an authentication code, wherein the receiver is provided in communication with an engine controller, the engine controller for processing the encrypted vehicle immobilization signal to determine if the immobilization signal is valid based on the authentication code and to immobilize if the immobilization signal is determined valid.

26. The method of claim 25 wherein the engine controller immobilizes the vehicle by limiting fuel to the vehicle engine.

27. The method of claim 25 wherein the receiver is part of a control unit, the control unit for mounting on the vehicle and including a controller in communication with the receiver, the controller for processing the tire information signals to convey tire pressure information to the vehicle occupant.

28. The method of claim 25 wherein the receiver is provided in communication with the engine controller over a data bus, and the receiver converts the vehicle immobilization signal for transmission to the engine controller over the data bus.

29. The method of claim 25 wherein the wireless encrypted vehicle immobilization signal is transmitted from a transmitter remote from the vehicle.

30. The system of claim 25 wherein the receiver is further for receiving a wireless signal for use in a remote keyless entry system.
